(19) United States
(12) Patent Application Publication
(10) Pub. No.: US 2023/0419984 A1
(43) Pub. Date: Dec. 28, 2023

(54) APPARATUS AND METHOD FOR CLEAN DIALOGUE LOUDNESS ESTIMATES BASED ON DEEP NEURAL NETWORKS

(71) Applicant: Fraunhofer-Gesellschaft zur Foerderung der angewandten Forschung e.V., Munich (DE)

(72) Inventors: Christian UHLE, Erlangen (DE); Michael KRATSCHMER, Erlangen (DE); Alessandro TRAVAGLINI, Erlangen (DE); Bernhard NEUGEBAUER, Erlangen (DE)

(21) Appl. No.: 18/465,070

(22) Filed: Sep. 11, 2023

Related U.S. Application Data
(63) Continuation of application No. PCT/EP2022/056020, filed on Mar. 9, 2022.

(30) Foreign Application Priority Data
Mar. 12, 2021 (WO) PCT/EP2021/056416

(51) Int. Cl. G10L 21/0364; G10L 21/034; G10L 25/30; G10L 25/21; G10L 25/18

(52) U.S. Cl. CPC G10L 21/0364; G10L 21/034; G10L 25/30; G10L 25/21; G10L 25/18

(57) ABSTRACT

An apparatus for providing an estimate of a loudness of signal components of interest of an audio signal is provided. The apparatus has an input interface configured to receive a plurality of samples of the audio signal. Moreover, the apparatus has a neural network configured to receive as input values the plurality of samples of the audio signal or a plurality of derived values being derived from the plurality of samples of the audio signal, and configured to determine at least one output value from the plurality of input values, such that the at least one output value indicates the estimate of the loudness of the signal components of interest of the audio signal.

### CROSS-REFERENCE TO RELATED APPLICATIONS

This application is a continuation of copending International Application No. PCT/EP2022/056020, filed Mar. 9, 2022, which is incorporated herein by reference in its entirety, and additionally claims priority from International Application No. PCT/EP2021/056416, filed Mar. 12, 2021, which is also incorporated herein by reference in its entirety.

### TECHNICAL FIELD

The present invention relates to loudness estimates based on neural networks, and in particular, to an apparatus and a method for providing an estimate of a loudness of signal components of interest of an audio signal.

### BACKGROUND OF THE INVENTION

Loudness monitoring in audio and television broadcasting and post-production has a long history, see [1]. It enables loudness control, i.e., to adjust the level of programme material such that it matches a target loudness, and thereby improves speech intelligibility and general user experience.

Three definitions of the input signal for loudness estimation are commonly used.

According to a first definition, the average loudness of the full input signal is estimated, and such an estimation is referred to as programme loudness (see [2]).

A second definition specifies that the loudness is estimated when the signal level is above threshold and thereby excluding quiet parts (gating) (see [2]).

According to a third definition, the dialogue loudness is estimated by estimating the loudness when speech is present (see [2])

The dialogue loudness is appropriate for loudness control because consistent dialogue loudness improves the intelligibility and the overall loudness consistency across programmes. Its measurement entails speech classification (see [4]) or Voice Activity Detection (VAD), (see [5]) to only take the parts of the programme into account when speech is present.

Joint learning of multiple related tasks, referred to as Multi-Task Learning (MTL), has first been proposed in [7]. Learning related tasks jointly can be easier, faster or more accurate than learning tasks in isolation.

Under some conditions MTL can lead to more robust models due to better generalization (see [7], [8], [9]). One reason for this is that additional targets provide additional data for learning the representations for solving the tasks. The benefit of MTL has been reported to be larger when only small amounts of data are available (see [10])

A potential disadvantages of MTL is that additional capacity is used. Also, hyperparameters (e.g., the learning rate and the batch size) are the same for each task (see [7], [11]), whereas when training tasks in isolation different settings for each task may yield better performance. Whether learning of a task benefits from learning additional tasks depends on the model, hyperparameter and the data and needs to be investigated empirically. This has been extensively studied in natural language processing (see [12], [13], [14]), computer vision (see [9]) and audio signal processing (see [15]).

What are related tasks and under which conditions does learning of one task benefit from simultaneously learning other tasks? Related tasks share the same input data and a low-dimensional feature representation which is jointly learned together with the task (see [7], [8], [16]). Therefore, a learning algorithm may generalize better then it learns the related tasks together than in isolation, but joint learning can also result in deteriorated performance, a phenomenon referred to as negative transfer (see [11]).

In the following, loudness metering in the known technology is described.

Loudness is the subjective quantity that corresponds to the intensity of sound. A long line of psychoacoustic research has investigated the human auditory system and perception (see [17], [18], [19]). Based on these findings, various models of loudness perception have been developed (see [19], [20], [21], [22]), which emulate the human ears.

An example is the model by Moore et. al. (see [21]), which is an extension of earlier research. It uses two transfer functions for modeling the transmission through the outer ear (when the sound source is presented in the free field and positioned in the front of the listener) and through the middle ear. The excitation level are computed for frequency bands with equivalent rectangular bandwidth (which is closely related to the critical bandwidth) using an auditory filterbank which emulates the frequency transform in the cochlea. The excitation levels are transformed to the specific loudness for each frequency band for sounds presented in quiet and in noise by modelling the nonlinearities of the inner and outer hair cells and partial masking. The specific loudness is summed across the auditory frequency bands to the monaural loudness and then doubled to account for binaural listening.

While computational models of loudness are very accurate in predicting the loudness for simple stimuli (e.g., sine waves or band-pass filtered noise) for a listener with normal hearing, it is more difficult for complex sounds, like music. Loudness models evolved from predicting synthetic to natural sounds, stationary signals to time-varying (see [22]), single-channel to binaural, correlated signal to uncorrelated and partially correlated signals. Further research aimed at reducing the complexity of loudness measurement to be applicable for broadcast applications by predicting the loudness as perceived by an average listener when presenting signals that are representative for these applications (see [23], [24], [25], [2]).

The recommendations (see [2], [24]) found widespread use in TV and radio broadcasting, streaming and other applications because they enable loudness metering at low cost with adequate accuracy for typical broadcast signal. The loudness is computed by means of a gating function to ignore quiet portions of the signal, a frequency weighting and energy averaging along time and weighted summation across signal channels.

The frequency weighting is implemented with a series connection of two biquad filters and is referred to as K-weighting. A high-shelving filter models the acoustic effect of the head as a rigid sphere and boosts the signal by 4 dB above the cut-off frequency of 1680 Hz (see [26]). The other filter aims to models the frequency weighting of human hearing. It is referred to a as “revised low-frequency B-weighting” (see [27]) and is a high-pass filter with a cut-off frequency of 38 Hz (see [26]). The loudness level according to [2] is computed from the mean square within short time intervals and converted in dB with a constant offset and is referred to as Program Loudness (PL).

Returning to the concept of dialog loudness, a drawback of the above definition of dialogue loudness is that it over-estimates the loudness when the speech is mixed with background sounds (e.g. music, sound effects or environmental sounds). For example, if the loudness difference between speech and background is 6 dB, the estimation error will be 1 dB. If background and speech have equal loudness, the estimation error will be 3 dB. Loudness normalization based on over-estimated loudness values will reduce the level compared to program material with very quiet background sounds. In mixed audio content, where intelligibility is often affected by background sounds partially masking the speech, this would worsen further the listening experience due to the resulting reduced playback levels.

The object of the present invention is to provide improved concepts for loudness estimates based on neural networks.

### SUMMARY

According to an embodiment, an apparatus for providing an estimate of a loudness of signal components of interest of an audio signal may have: an input interface configured to receive a plurality of samples of the audio signal, and a neural network configured to receive as input values the plurality of samples of the audio signal or a plurality of derived values being derived from the plurality of samples of the audio signal, and configured to determine at least one output value from the plurality of input values, such that the at least one output value indicates the estimate of the loudness of the signal components of interest of the audio signal.

According to another embodiment, a system for modifying an audio input signal to obtain an audio output signal may have: an inventive apparatus as mentioned above for providing an estimate of a loudness of signal components of interest of the audio input signal, and a signal processor configured to modify the audio input signal depending on the estimate of the loudness of the signal components of interest of the audio input signal to obtain the audio output signal.

According to another embodiment, a method for providing an estimate of a loudness of signal components of interest of an audio signal may have the steps of: receiving a plurality of samples of the audio signal, and estimating the loudness of the signal components of interest of the audio signal, wherein a neural network receives as input values the plurality of samples of the audio signal or a plurality of derived values being derived from the plurality of samples of the audio signal, and wherein the neural network determines at least one output value from the plurality of input values, such that the at least one output value indicates the estimate of the loudness of the signal components of interest of the audio signal.

Another embodiment may have a non-transitory digital storage medium having stored thereon a computer program for performing a method of for providing an estimate of a loudness of signal components of interest of an audio signal, the method having the steps of: receiving a plurality of samples of the audio signal, and estimating the loudness of the signal components of interest of the audio signal, wherein a neural network receives as input values the plurality of samples of the audio signal or a plurality of derived values being derived from the plurality of samples of the audio signal, and wherein the neural network determines at least one output value from the plurality of input values, such that the at least one output value indicates the estimate of the loudness of the signal components of interest of the audio signal, when the computer program is run by a computer or signal processor.

An apparatus for providing an estimate of a loudness of signal components of interest of an audio signal is provided. The apparatus comprises an input interface configured to receive a plurality of samples of the audio signal. Moreover, the apparatus comprises a neural network configured to receive as input values the plurality of samples of the audio signal or a plurality of derived values being derived from the plurality of samples of the audio signal, and configured to determine at least one output value from the plurality of input values, such that the at least one output value indicates the estimate of the loudness of the signal components of interest of the audio signal.

Moreover, a method for providing an estimate of a loudness of signal components of interest of an audio signal is provided. The method comprises:
Receiving a plurality of samples of the audio signal. And:
Estimating the loudness of the signal components of interest of the audio signal.

A neural network receives as input values the plurality of samples of the audio signal or a plurality of derived values being derived from the plurality of samples of the audio signal. The neural network determines at least one output value from the plurality of input values, such that the at least one output value indicates the estimate of the loudness of the signal components of interest of the audio signal.

Furthermore, a computer program for implementing the above-described method when being executed on a computer or signal processor is provided.

Embodiments are applicable for the estimation of the clean dialog level in broadcast material comprising speech and background sounds. In embodiments, this measurement may, e.g., be used for loudness control of audio signals. Loudness normalization based on clean dialogue loudness improves the consistency of the dialogue level compared to the loudness of the full program measured at speech or signal activity.

Some embodiments may, e.g., use a deep neural network with convolutional and fully connected layers. The model is trained with input signals and target values computed using the separately available speech and background signals to estimate the loudness of the clean dialog. Additionally the model may, e.g., be trained to estimate the loudness of the background, and the loudness of the mixture signal to further improve the accuracy of the clean dialogue loudness.

Embodiments provide an estimation of the Clean Dialog Loudness (CDL) in broadcast material comprising speech and background sounds for loudness monitoring and control. The term “clean dialog” is used to refer to the speech signal isolated from other sounds.

Some embodiments may, e.g., employ a Deep Neural Network (DNN) with convolutional layers (see [6]) and fully connected layers (FLs).

In some embodiments, the DNN may, e.g., be augmented with an additional output to estimate the programme loudness, the loudness of the background and to detect speech activity at low additional computational cost.

According to some embodiments, the information from the auxiliary tasks may, e.g., be applied by applying measures for the reliability of the estimation and by using them for post-processing of the estimated CDL.

In some embodiments, when no speech is present, the program loudness may, e.g., be used instead of speech-based levels.

According to some embodiments, means may, e.g., be provided to compensate for partial masking due to the background sounds by raising the playback level.

In some embodiments, it may, e.g., be investigated how learning of auxiliary targets improves the performance on the primary task.

Some embodiments relate to clean dialogue loudness (CDL) which represents the loudness of the speech signals within a mixture and which enables loudness control with consistent dialogue loudness.

Some embodiments are based on deep learning for estimating the CDL when isolated speech signals are not available.

In some embodiments learning auxiliary tasks may, e.g., be employed to improve the accuracy of the estimation by providing additional information for post-processing. The proposed method additionally enables loudness control that also takes the partial masking of the speech by the background sounds into account.

### BRIEF DESCRIPTION OF THE DRAWINGS

In the following, embodiments of the present invention are described in more detail with reference to the figures, in which:

FIG. 1 illustrates an apparatus for providing an estimate of a loudness of signal components of interest of an audio signal according to an embodiment;

FIG. 2 illustrates a neural network according to an embodiment;

FIG. 3 illustrates a system for modifying an audio input signal to obtain an audio output signal according to an embodiment;

FIG. 4 illustrates a bandwidth of frequency bands and the Equivalent Rectangular Bandwidth at higher frequencies according to an embodiment;

FIG. 5 illustrates learning curves according to embodiments;

FIG. 6 shows the Mean Absolute Errors for different Signal to Noise Ratios for mixing speech and background to create the test signals according to embodiments;

FIG. 7 illustrates an evaluation of momentary loudness for different Signal to Noise Ratios and averaged after post-processing according to embodiments; and

FIG. 8 illustrates an evaluation of short-term loudness according to an embodiment.

### DETAILED DESCRIPTION OF THE INVENTION

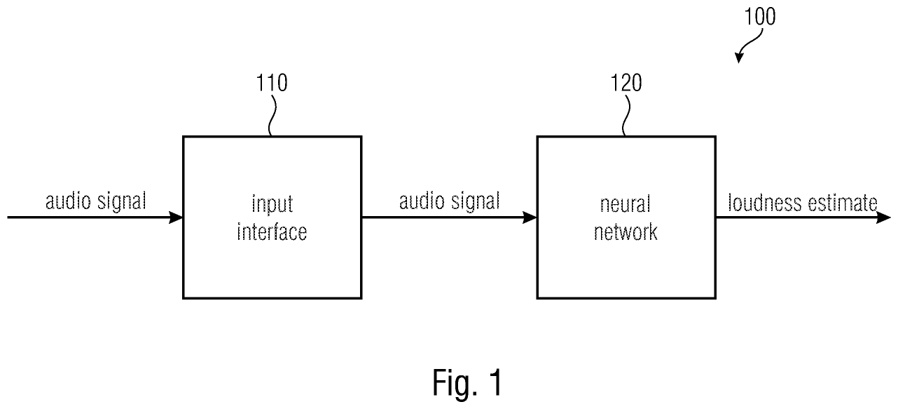

FIG. 1 illustrates an apparatus 100 for providing an estimate of a loudness of signal components of interest of an audio signal according to an embodiment.

The apparatus 100 comprises an input interface 110 configured to receive a plurality of samples of the audio signal.

Moreover, the apparatus 100 comprises a neural network 120 configured to receive as input values the plurality of samples of the audio signal or a plurality of derived values being derived from the plurality of samples of the audio signal. Furthermore, the neural network 120 is configured to determine at least one output value from the plurality of input values, such that the at least one output value indicates the estimate of the loudness of the signal components of interest of the audio signal.

According to an embodiment, the audio signal may, e.g., simultaneously comprise the signal components of interest and other signal components of the audio signal. An influence of the other signal components on the estimate of the loudness of the signal components of interest may, e.g., be reduced or not present.

The above embodiments are based on the finding that training a neural network for estimating a loudness of the signal components of interest has the significant advantage that a signal decomposition of the audio signal into the signal components of interest and into the other signal components prior to the loudness estimation is no longer necessary. By this, an acceleration of the loudness estimation at runtime is achieved.

In an embodiment, the signal components of interest of the audio signal may, e.g., be speech components of the audio signal. The neural network 120 may, e.g., be configured to determine the at least one output value from the plurality of input values, such that the at least one output value may, e.g., indicate the estimate of the loudness of the speech components of the audio signal.

According to an embodiment, the audio signal may, e.g., simultaneously comprise the speech components and background components of the audio signal. An influence of the background components on the estimate of the loudness of the speech components may, e.g., be reduced or not present.

Again, also in those embodiments, which relate to the estimation of the loudness of speech components, training a neural network for estimating the loudness of the speech components has the significant advantage that a signal decomposition of the audio signal into the speech components and into the background components prior to the loudness estimation is not necessary, and by this, an acceleration of the loudness estimation of the speech components at runtime is achieved.

In an embodiment, the signal components of interest of the audio signal may, e.g., be sound components of at least one first sound source out of a plurality of sound sources in an environment. The audio signal may, e.g., simultaneously comprise the sound components of the at least one first sound source and other sound components of one or more other sound sources out of the plurality of sound sources in the environment. The neural network 120 may, e.g., be configured to determine the at least one output value from the plurality of input values, such that the at least one output value may, e.g., indicate the estimate of the loudness of the sound components of the at least one first sound source. An influence of the other sound components of the one or more other sound sources on the estimate of the loudness of the sound components of the at least one first sound source may, e.g., be reduced or not present.

According to an embodiment, the sound components of the at least one first sound source may, e.g., be speech components of a first person out of a plurality of persons speaking in the environment. The other sound components of the one or more other sound sources may, e.g., be other speech components of one or more other persons out of the plurality of persons speaking in the environment. The audio signal may, e.g., simultaneously comprise the speech components of the first person and the other speech components of the one or more other persons speaking in the environment. The neural network 120 may, e.g., be configured to determine the at least one output value from the plurality of input values, such that the at least one output value may, e.g., indicate the estimate of the loudness of the speech components of the first person. An influence of the other speech components of the one or more other persons on the estimate of the loudness of the speech components of the first person may, e.g., be reduced or not present.

In an embodiment, the sound components of the at least first sound source may, e.g., be sound components of at least one non-human sound source out of a plurality of non-human sound sources in an environment. The other sound components of the one or more other sound sources may, e.g., be other sound components of one or more other non-human sound source out of the plurality of non-human sound sources. The audio signal may, e.g., simultaneously comprise the sound components of the at least one first non-human sound source and the other sound components of the one or more other non-human sound sources in the environment. The neural network 120 may, e.g., be configured to determine the at least one output value from the plurality of input values, such that the at least one output value may, e.g., indicate the estimate of the loudness of the sound components of the at least one first non-human sound source. An influence of the other sound components of the one or more other non-human sound sources on the estimate of the loudness of the sound components of the at least one first non-human sound source may, e.g., be reduced or not present.

According to an embodiment, the sound components of the at least one first sound source may, e.g., be a singing of one or more singers in the environment. The other sound components of the one or more other sound sources may, e.g., be sound components of accompanying musical instruments, which accompany the singing of the one or more singers in the environment. The audio signal may, e.g., simultaneously comprise the signing of the one or more singers and the sound components of the accompanying musical instruments. The neural network 120 may, e.g., be configured to determine the at least one output value from the plurality of input values, such that the at least one output value may, e.g., indicate the estimate of the loudness of the singing. An influence of the sound components of accompanying musical instruments on the estimate of the loudness of the singing may, e.g., be reduced or not present.

In an embodiment, the neural network 120 may, e.g., be configured to determine at least one further output value indicating an estimate of a loudness of the entire audio signal.

According to an embodiment, the neural network 120 may, e.g., be configured to determine one or more further output values indicating an estimate of a loudness of the audio signal when speech may, e.g., be present.

In an embodiment, the neural network 120 may, e.g., be configured to determine another one or more output values indicating an estimate of a loudness of background components of the audio signal.

According to an embodiment, the apparatus 100 may, e.g., be configured to determine and output at least one other output value indicating an estimate of a partial loudness of the speech components of the audio signal. The partial loudness of the speech components of the audio signal may, e.g., depend on the loudness of the speech components of the audio signal and on the loudness of background components of the audio signal.

According to an embodiment, the apparatus 100 may, e.g., comprise a postprocessor, configured to modify the estimate of the loudness of the signal components of interest of the audio signal depending on confidence information, and/or configured to output the confidence information. The confidence information may, e.g., indicate a reliability on whether or not the estimate of the loudness of the signal components of interest of the audio signal conducted by the neural network 120 may, e.g., be reliable, or wherein the confidence information may, e.g., indicate one or more values indicating a degree of reliability of the estimate of the loudness of the signal components of interest of the audio signal conducted by the neural network 120.

In an embodiment, the postprocessor may, e.g., be configured to determine as the confidence information whether or not the at least one output value provided by the neural network 120 may, e.g., indicate that the estimate of the loudness of the signal components of interest of the audio signal would higher than a total loudness of the audio signal. If the at least one output value provided by the neural network 120 indicates that the estimate of the loudness of the signal components of interest of the audio signal would be higher than a total loudness of the audio signal, the postprocessor may, e.g., be configured to modify the estimate of the loudness of the signal components of interest such that the loudness of the signal components of interest of the audio signal may, e.g., be equal to the total loudness of the audio signal. For example, a low value would be determined as confidence information. Or, the postprocessor may, e.g., be configured to output the confidence information comprising an indication that the estimate of the loudness of the signal components of interest of the audio signal may, e.g., be not reliable.

According to an embodiment, the postprocessor may, e.g., be configured to determine and to output the confidence information comprising a confidence value that may, e.g., indicate the degree of reliability of the estimate of the loudness of the signal components of interest of the audio signal conducted by the neural network 120, such that the confidence value may, e.g., depend on the estimate of the loudness of the signal components of interest of the audio signal and may, e.g., further depend on a loudness or an estimate of a loudness of the other signal components of the audio signal.

In an embodiment, the confidence value may, e.g., depend on a difference between the estimate of the loudness of the signal components of interest of the audio signal and the loudness or the estimate of the loudness of the other signal components of the audio signal. Or, the confidence value may, e.g., depend on a ratio of the estimate of the loudness of the signal components of interest of the audio signal and the loudness or the estimate of the loudness of the other signal components of the audio signal.

According to an embodiment, the neural network 120 has been trained using a plurality of data training items. Each of the plurality of data training items comprises one of a plurality of audio training signal portions and one or more reference loudness values.

In an embodiment, the neural network 120 has been trained depending on a loss function. To determine a return value of the loss function during training, the neural network 120 may, e.g., be configured to determine one or more loudness value estimates of the audio training signal portion for each of one or more data training items of the plurality of data training items. The neural network 120 has been trained depending on the loss function such that a return value of the loss function may, e.g., depend on the one or more loudness value estimates of the audio training signal portion and on the one or more reference loudness values of each of the one or more data training items.

According to an embodiment, one of the one or more reference loudness values of a data training item of the one or more data training items may, e.g., indicate a loudness of the signal components of interest of the audio training signal portion of the data training item, and wherein one of the one or more loudness value estimates of the data training item may, e.g., indicate an estimate of said loudness of the signal components of interest of the audio training signal portion of the data training item by the neural network 120.

In an embodiment, one of the one or more reference loudness values of a data training item of the one or more data training items may, e.g., indicate a loudness of the other signal components of the audio training signal portion of the data training item, and wherein one of the one or more loudness value estimates of the data training item may, e.g., indicate an estimate of said loudness of the other signal components of the audio training signal portion of the data training item by the neural network 120.

According to an embodiment, one of the one or more reference loudness values of a data training item of the one or more data training items may, e.g., indicate a loudness of the entire audio training signal portion of the data training item, and wherein one of the one or more loudness value estimates of the data training item may, e.g., indicate an estimate of said loudness of the entire audio training signal portion of the data training item by the neural network 120.

In an embodiment, one of the one or more reference loudness values of a data training item of the one or more data training items may, e.g., indicate a loudness of the audio training signal portion of the data training item when speech may, e.g., be present, and wherein one of the one or more loudness value estimates of the data training item may, e.g., indicate an estimate of said loudness of the audio training signal portion of the data training item by the neural network 120 when speech may, e.g., be present.

According to an embodiment, one of the one or more reference loudness values of a data training item of the one or more data training items may, e.g., indicate a partial loudness of the signal components of interest the audio training signal portion of the data training item, and wherein one of the one or more loudness value estimates of the data training item may, e.g., indicate an estimate of said partial loudness of the signal components of interest of the audio training signal portion of the data training item by the neural network 120.

In an embodiment, the loss function may, e.g., be defined according to

$$Loss = \frac{1}{N} {\sum }_{i = 1}^{N} {( {estimate}_{i} - {reference}_{i} )}^{p}$$

Loss indicates the return value of the Loss function, estimateᵢ indicates one of the one or more loudness value estimates of an i-th data training item of the one or more data training items, referenceᵢ indicates one of the one or more reference loudness values of the i-th data training item of the one or more data training items, wherein p≥1 is a parameter controlling the effect of large differences on the Loss, and wherein N≥1 is the number of data training items used for computing the Loss.

According to an embodiment, the neural network 120 has been trained by iteratively adjusting the plurality of weights of the plurality of neural nodes of the neural network 120. In each iteration step of a plurality of iteration steps, the plurality of weights of the plurality of neural nodes of the neural network 120 has been adjusted depending on one or more errors returned by the loss function in response to receiving the one or more data training items.

In an embodiment, one of the one or more reference loudness values of one of the one or more data training items may, e.g., depend on one or more modified coefficients of the audio training signal portion of the data training item. The one or more modified coefficients of the audio training signal portion of the data training item may, e.g., depend on one or more initial coefficients of the audio training signal portion of the data training item.

According to an embodiment, the one or more modified coefficients of the audio training signal portion of the data training item depend on an application of a filter on the one or more initial coefficients of said audio training signal portion. Or, the one or more modified coefficients of the audio training signal portion of the data training item depend on a spectral weighting of the one or more initial coefficients of the signal components of interest of said audio training signal portion.

In an embodiment, the one or more modified coefficients indicate an squaring of each of one or more filtered coefficients which result from the application of the filter on the one or more initial coefficients. Or, the one or more modified coefficients indicate an squaring of each of one or more spectrally weighted coefficients which result from the spectral weighting of the one or more initial coefficients.

According to an embodiment, the filter may, e.g., depend on a psychoacoustic model, or the spectral weighting may, e.g., depend on the psychoacoustic model.

In an embodiment, said one of the one or more reference loudness values may, e.g., depend on a sum or a weighted sum of at least two of the modified coefficients.

According to an embodiment, said one of the one or more reference loudness values may, e.g., depend on

$$L = {a ( \frac{1}{N} {\sum }_{1}^{T} {x}^{2} )}^{b}$$

wherein x² indicates a square of a modified coefficient of the at least two of the modified coefficients, wherein T is an integer indicating a number of the at least two of the modified coefficients, wherein a and N are predefined numbers, and 0<b<1. L may, e.g., indicate said one of the one or more reference loudness values.

According to an embodiment, said one of the one or more reference loudness values may, e.g., depend on

$$L = a {log}_{b} ( \frac{1}{N} {\sum }_{1}^{T} {x}^{2} )$$

wherein x² indicates a square of a modified coefficient of the at least two of the modified coefficients, wherein T is an integer indicating a number of the at least two of the modified coefficients, wherein log indicates a logarithmic function being the compressive function, and wherein a, b and N are predefined numbers. L may, e.g., indicate said one of the one or more reference loudness values.

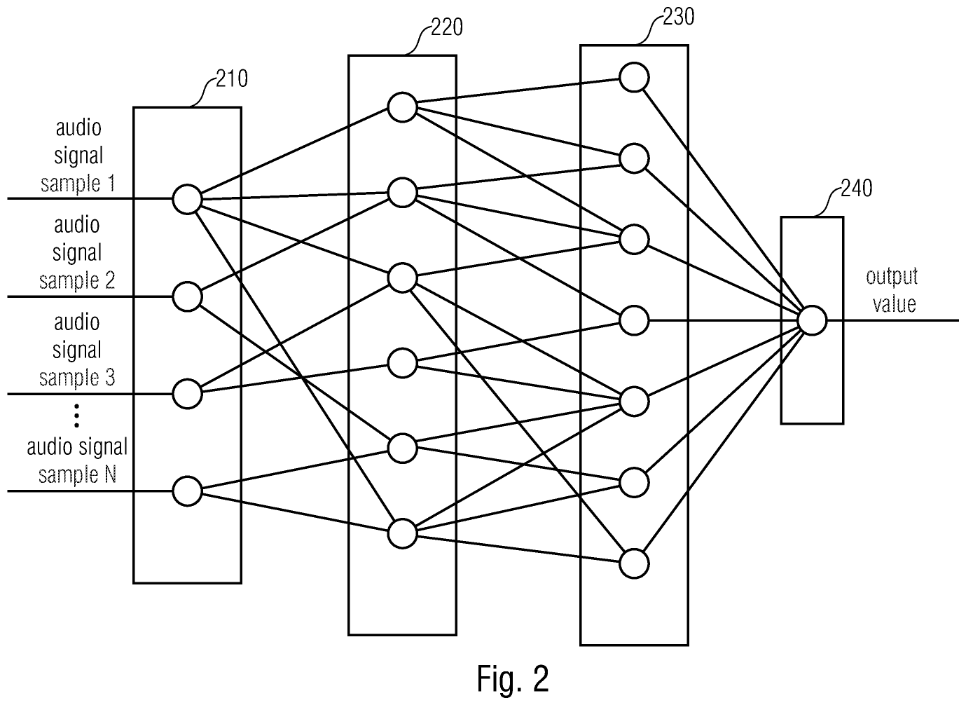

FIG. 2 illustrates a neural network 120 according to an embodiment. The neural network 120 comprises an input layer, two or more hidden layers, and an output layer. The input layer comprises a plurality of input nodes, wherein each of the plurality of input nodes is configured to receive one of the plurality of input values. Each of the two or more hidden layers comprises one or more neural nodes. The output layer comprises at least one output node, wherein the at least one output node is configured to output the at least one output value indicating the estimate of the loudness of the signal components of interest of the audio signal.

According to an embodiment, at least one layer of the two or more hidden layers may, e.g., be a convolutional layer.

In an embodiment, the neural network 120 may, e.g., be configured to employ a convolutional filter for the convolutional layer, which has a shape (x, y), with x=y or with x≠y, wherein max (x, y)≤10.

According to an embodiment, at least one layer of the two or more hidden layers may, e.g., be a fully connected layer.

In an embodiment, the hidden layers comprise at least one convolutional layer, at least one pooling layer, and at least one fully connected layer.

According to an embodiment, the apparatus 100 may, e.g., be configured to employ linear activation in the output layer of the neural network 120.

According to an embodiment, the hidden layers of the neural network 120 comprise at least three succeeding layers. A first one of the at least three succeeding layers may, e.g., be not a convolutional layer. A second one of the at least three succeeding layers, which immediately succeeds the first one of the at least three succeeding layers in the neural network 120, may, e.g., be a convolutional layer. A third one of the at least three succeeding layers, which immediately succeeds the second one of the at least three succeeding layers in the neural network 120, may, e.g., be a pooling layer.

In an embodiment, the input interface 110 may, e.g., be configured to receive a plurality of spectral samples of the audio signal as the plurality of input values. The neural network 120 may, e.g., be configured to determine the estimate of the loudness of the signal components of interest of the audio signal depending on the plurality of power spectral samples of the audio signal.

According to an embodiment, the plurality of spectral samples are power spectral samples of at least 32 frequency bands.

In an embodiment, the plurality of spectral samples of the audio signal represent the audio signal in a time-frequency domain.

According to an embodiment, the apparatus 100 further comprises a transform module configured for transforming the audio signal from a time domain to the time-frequency domain to obtain the plurality of spectral samples of the audio signal.

In an embodiment, the transform module may, e.g., be configured to transform segments of the audio signal of at least 100 ms length from the time domain to the time-frequency domain to obtain the plurality of spectral samples of the audio signal.

According to an embodiment, a first group of two or more of the plurality of spectral samples relate to a first group of frequency bands, which each exhibit a bandwidth that deviates by no more than 10% from a predefined first bandwidth. A second group of two or more of the plurality of spectral samples relate to a second group of frequency bands, which each exhibit a higher center frequency than each frequency band of the first group of frequency bands, and which each exhibit a bandwidth being higher than the bandwidth of each frequency band of the first group.

In an embodiment, a third group of two or more of the plurality of spectral samples relate to a third group of frequency bands, which each exhibit a higher center frequency than each frequency band of the second group of frequency bands, which each exhibit a bandwidth being higher than the bandwidth of each frequency band of the second group. The bandwidth of each frequency band of the third group deviates less from an equivalent rectangular bandwidth than the bandwidth of each frequency band of the second group.

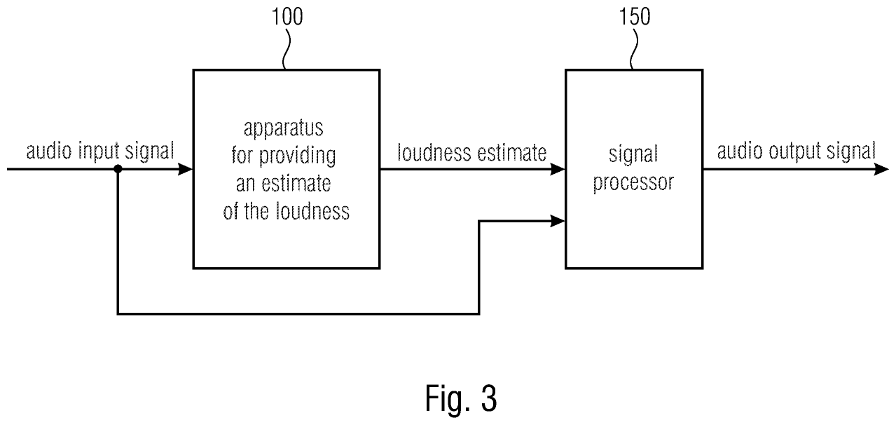

FIG. 3 illustrates a system for modifying an audio input signal to obtain an audio output signal according to an embodiment.

The system comprises the apparatus 100 of FIG. 1 for providing an estimate of a loudness of signal components of interest of the audio input signal.

Moreover, the system comprises a signal processor 150 configured to modify the audio input signal depending on the estimate of the loudness of the signal components of interest of the audio input signal to obtain the audio output signal.

According to an embodiment, the signal components of interest of the audio signal are speech components of the audio signal. The signal processor 150 may, e.g., be configured to modify the audio input signal depending on the estimate of the loudness of the speech components of the audio input signal to obtain the audio output signal.

In an embodiment, the signal processor 150 may, e.g., be configured to modify the audio input signal depending on the estimate of the loudness of the speech components of the audio input signal and depending on an estimation of the loudness of the background components of the audio input signal to obtain the audio output signal.

According to an embodiment, the signal processor 150 may, e.g., be configured to modify a level of the audio input signal depending on the partial loudness of the speech components of the audio signal.

Particular embodiments of the present invention are now described in more detail.

At first, estimating the Clean Dialog Loudness according to particular embodiments is described.

According to some embodiments, a DNN is trained to estimate the CDL as primary target jointly with auxiliary targets. The basic approach is supervised learning by means of inductive inference where the network learns a function ƒ:X→y that maps an input space X to an output space y using empirical risk minimization (ERM) with loss functions and optional regularization functions. Given is a training data set D={dᵢ=(Xᵢ, yᵢ)∈X×y}: comprising N data points D˜P_{x×y} sampled from some joint distribution over the input and output space.

The aim may, e.g., be defined to minimize the true risk

R(ƒ)=E{l(ƒ(X),y)}

with expectation operator E{⋅} and loss function l(ƒ(X), y) and to find an optimal function

$${f}^{*} = {argmin}_{f} R ( f ) .$$

To this end a loss function l(ƒ(X), y) may, e.g., be defined as a metric that quantifies the performance of ƒ based on the differences yᵢ−ƒ(Xᵢ) and minimize the empirical risk defined as

$$\hat{R} ( f ) = \frac{1}{N} {\sum }_{i = 1}^{N} l ( f ( {X}_{i} ) , {y}_{i} ) .$$

In the following, the neural network input of particular embodiments is described.

The input to the neural network may, for example, be logarithmic power spectra computed from 39 overlapping frames from segments of 400 ms length each with 128 frequency bands.

The magnitudes for each sub-band may, for example, be computed from overlapping frames from the single-channel input signals, for example, sampled at 48 kHz, e.g., using a Short-Time Fourier Transform (STFT), for example, with a frame size of 20 ms and 10 ms hop and a Hann window function.

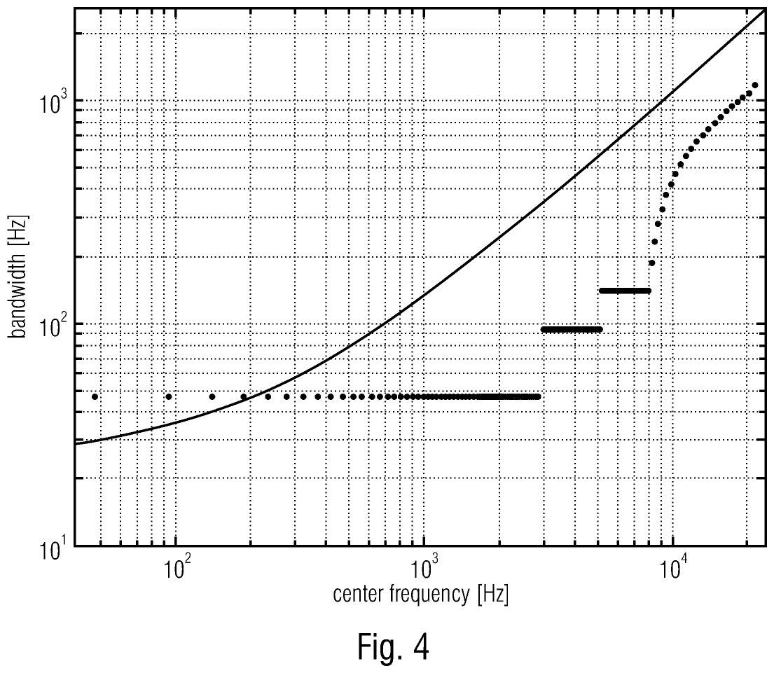

FIG. 4 illustrates a bandwidth of frequency bands (dots) and for comparison the ERB (solid line) according to an embodiment.

The frequency resolution shown in FIG. 4 is chosen such that the lower bands have the resolution of the STFT (47 Hz), the width of the following frequency bands increases to twice and threefold of the STFT bin width, and approaches the Equivalent Rectangular Bandwidth (ERB) at higher frequencies.

In embodiments, for example, 128 bands instead of the full STFT resolution with 512 coefficients may, e.g., be used to reduce the number of inputs and the neural network complexity. Previous works suggest 40 bands for VAD (see [28]), 64 bands (see [29]) for general audio classification and 128 bands (covering the frequency range of 22050 Hz) (see [30]) for environmental sound classification.

When sub-band energy levels are computed from multiple adjacent bins their squared magnitude spectral coefficients may, e.g., be added. The data may, e.g., be centered and normalized using means and standard deviations computed from the training data along the time axis.

With respect to the neural network output, the neural network may, e.g., be trained to estimate the CDL, the loudness of the background signal, and the PL.

The loudness values of the signals for the training may, for example, be computed according to the concepts provided in [2]. The gating from [2] may, for example, not be applied when computing the target loudness, because it may be difficult for the neural network to learn and it may, e.g., be applied as post-processing.

In the following, the neural network structure according to particular embodiments is described.

CNNs (convolutional neural networks) have been used for audio classification and similar tasks with good results (see [29], [30], [28]) and are easy to implement and train. During inference many computations can be parallelized to accelerate the processing.

VGG-ish structures (see [31]) may, for example, be employed, which were highly successful in classification and localisation tasks of the ImageNet Challenge 2014 (see [32]) and have successfully been applied to audio classification (see [29]). They are well-suited for the shape of our input data and easy to train.

In embodiments, these structures may, e.g., be modified to reduce the number parameters, computational load and memory requirements.

VGG (an abbreviation of Visual Geometry Group at the University of Oxford) is a DNN with CLs with small convolutional filters of shape (3×3), stride of one and padding such that the input and output shape of each layer are equal.

In some embodiments, large receptive fields may, e.g., be obtained by stacking CLs and Maxpooling layers with pooling size (2,2) to reduce the data rate transmitted through the neural network.

According to some embodiments, the stack of CLs and Maxpooling layers may, e.g., be followed by three FLs.

For example, all CLs and the hidden FLs may, e.g., use RelU activation (see [33]).

In some embodiments, linear activations may, e.g., be used in the final layer, because loudness estimation is a regression tasks.

Multiple configurations with up to 19 layers have been proposed (see [31]). In some embodiments, the neural network variants VGG-B and VGG-D from are compared with a reduced number of 1000 neurons in the hidden FLs to account for the smaller number of outputs.

According to an embodiment, the neural network VGG-B may, e.g., (then) be modified, for example, by using only one CL before each pooling layer instead of two, and/or by reducing the number of FLs, and/or by reducing the number of filters in the CLs, and/or by reducing the number of neurons in the FLs.

The resulting neural network configurations may, for example, be referred to as VGGc-u-v-w, with number of CL before each pooling layer c, maximum number of filters in the CLs u, number of FLs v, and number of neurons in the FLs w.

No means for regularization, e.g., dropout, has been used because no severe overfitting occurs inter alia, because of the employed generation of the input data described below.

Table 1 illustrates an example for the parametrization of selected neural network configurations.

TABLE 1
Overview of DNN configurations.

| | Number | Number | Number |
|---|---|---|---|
| Model name | of CLs | of FLS | of param. |
| VGG-B | 10 | 3 | 11,945,844 |
| VGG1-128-2-125 | 5 | 2 | 565,877 |
| VGG1-64-2-125 | 5 | 2 | 154,229 |

Now, neural network training according to particular embodiments is described.

The neural network may, for example, be trained with a batch size of 64 with optimizer Adam (see [34]) with learning rate=0.0001, β₁=0.9, β₂=0.999, and e=10⁻⁸. Loss function for all tasks is the Mean Squared Error (MSE). Neural network weights may, for example, be initialized as proposed in [35].

Mixture signals xᵢ(t)=g_{s,j}sⱼ(t+t_{s,j})+g_{n,k}nₖ (t+t_{n,k}) of randomly selected clean speech signals sⱼ(t) and background signal nₖ(t) with randomized time offsets t_{s,j} and nₖ(t) and randomized gains g_{s,j} and g_{n,k} may, e.g., be used for the training, where mixtures of combinations of all speech and background signals can be synthesized.

Training and inference of the neural networks have been implemented using Tensorflow with the Keras frontend.

Reference values for training the CDL neural network may, e.g., be computed based on the concepts provided in [2].

In the following, post-processing according to particular embodiments is described.

In embodiments, estimates of the CDL may, for example, be computed for successive and possible overlapping segments.

According to some embodiments, post-processing may, e.g., be applied to these estimates to improve their accuracy. The true CDL is not larger than the PL (when no gating is applied) and the CDL may, e.g., therefore be limited with the PL.

In an embodiment, in low SNR conditions which are detected when the CDL drops below the PL by more than 3 dB the estimation is prone to error, the estimated quantities may, e.g., be ignored.

According to an embodiment, robust estimates of the long-term CDL may, e.g., be advantageously obtained when a sufficiently large number of segment yield valid results. When no speech is present or the speech activity is low, CDL is not defined and can't be estimated.

To this end, in some embodiments, a threshold may, e.g., be defined for speech activity. E.g., less than 5% of all segments contain speech, and PL instead of CDL or a level value derived from the PL may, e.g., be used.

With respect to the momentary loudness and short-term loudness, loudness estimates are usually displayed on different time scales. The recommendation (see [36]) averages loudness estimates within a rectangular time windows of 400 ms to compute a momentary loudness without gating (see [2]) and a time window of 3 s to compute a short-term loudness.

In some embodiments, the computation of the short-term loudness may, e.g., be modified in two aspects: Gating (see [2]) may, e.g., be used and/or the time window may, e.g., be increased to a length of 5 s.

The data for training data may, for example, be generated from single-channel recordings of clean speech (31 hours length) and various sources for background sounds: environmental noise and sound effects (24.8 hours), musical recordings (82.4 hours) and recordings of musical instruments (3 hours).

The signals for testing may, for example, be produced with the same procedure as for training but with different data sets. The speech signals may, e.g., be recorded speech signals. The background signals may, e.g., be taken from movie excerpts by manually editing the signals to remove all speech occurrences.

In the following, evaluation aspects according to particular embodiments are discussed.

At first, a comparison of neural network sizes is conducted.

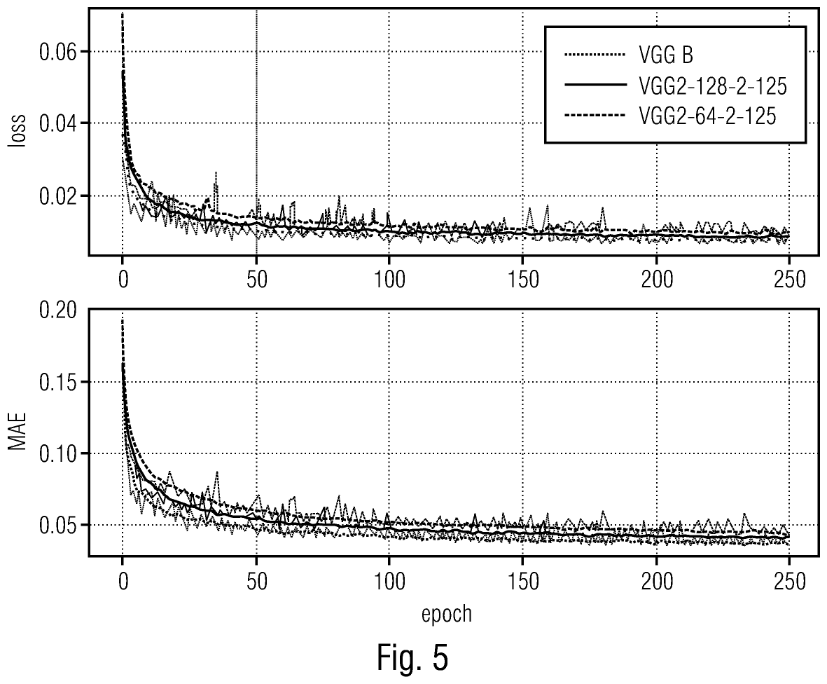

FIG. 5 illustrates learning curves according to an embodiment. In particular, FIG. 5 illustrates learning curves which depict the combined loss and Mean Absolute Error (MAE) as function of training epochs. In particular, he upper plot shows the evolution of the loss (MSE), the lower plot the evaluation metric (MAE). Results on training data (solid lines) and test data (dotted lines).

FIG. 5 shows that the original neural networks can be substantially simplified without severely degrading the performance on the training data which is highly beneficial because it enable an implementation of the proposed method with lower computational load and memory requirements. An indication of overfitting was not observed, but the test results show a much higher volatility than the training results.

Now, momentary loudness aspects are discussed.

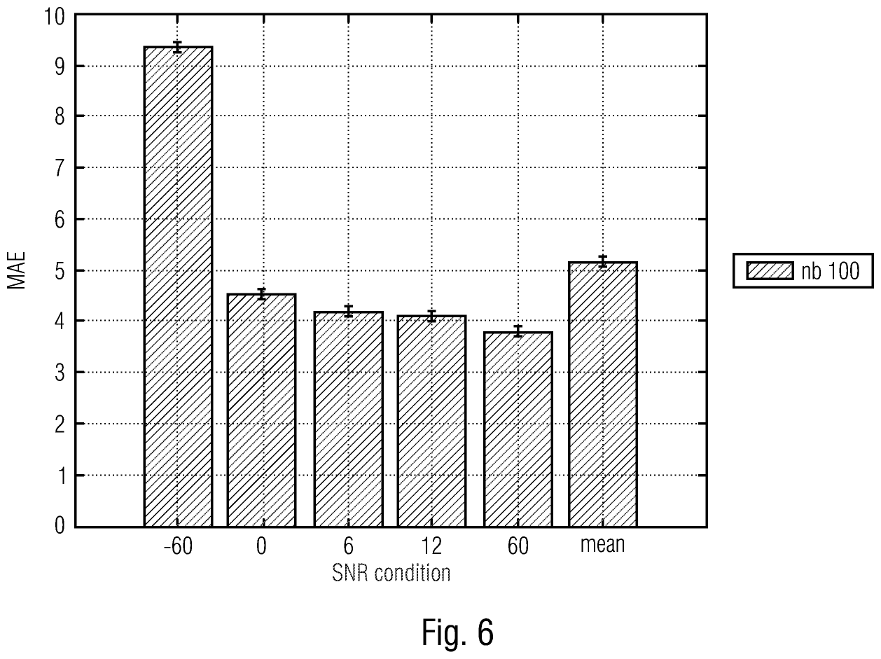

FIG. 6 shows the MAEs for different Signal to Noise Ratios (SNRs) for mixing speech and background to create the test signals. In particular, FIG. 6 illustrates an evaluation of momentary loudness for 5 SNRs and averaged. The SNR of −60 dB is equivalent to a signal without speech. The SNR of 60 dB is equivalent to a signal where to background signal has a negligible effect of the loudness measurement.

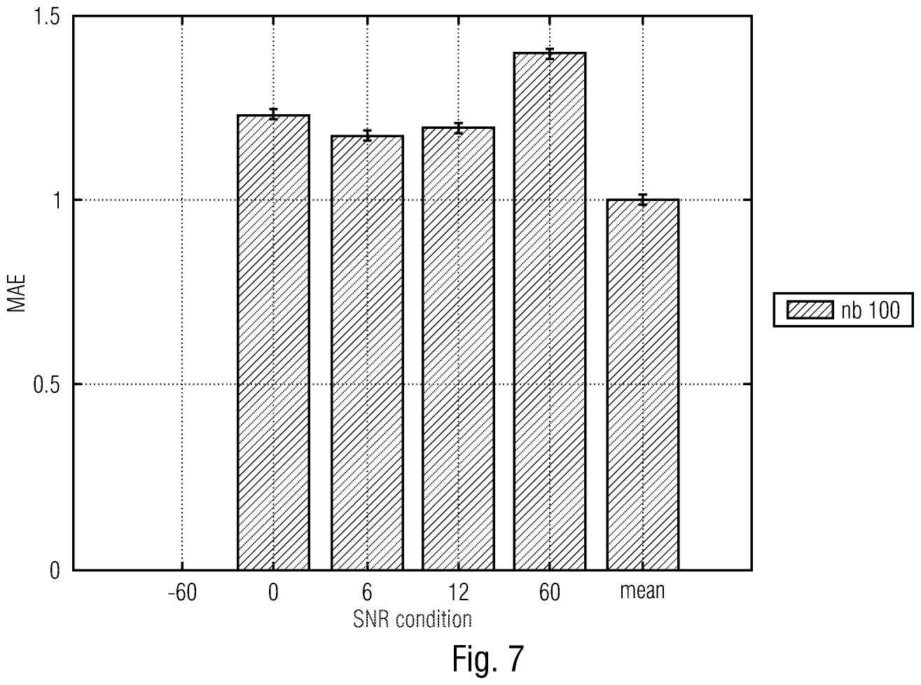

FIG. 7 shows the MAEs for different SNR conditions after the post-processing described above. In particular, FIG. 7 illustrates an evaluation of momentary loudness for 5 SNRs and averaged after post-processing. For the momentary loudness estimate the neural network achieves MAEs of about 1 dB on average.

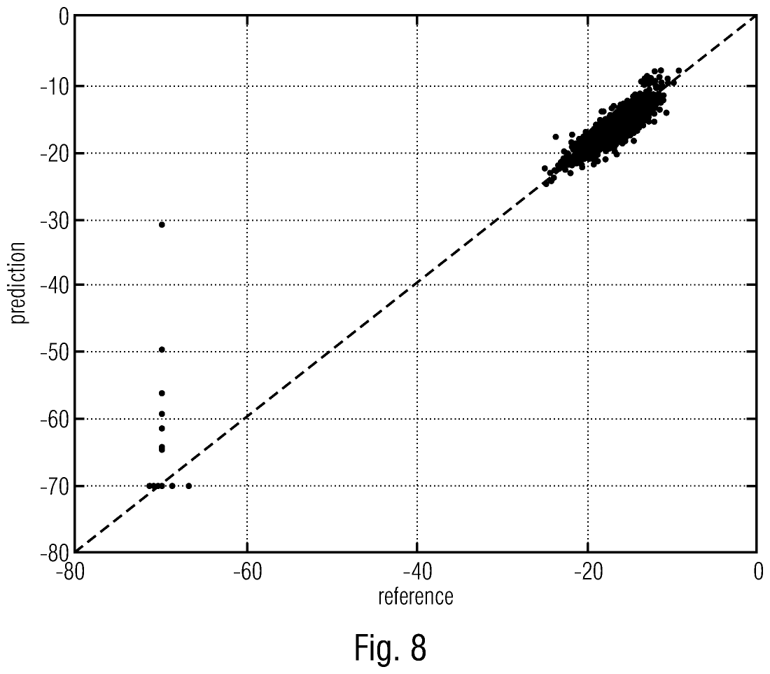

With respect to short-term loudness FIG. 8 illustrates an evaluation of short-term loudness according to an embodiment. In particular, FIG. 8 shows the results obtained from the test data set which have an MAE of 0.67 dB.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] B. Bauer, E. Torick, A. Rosenheck, and R. Allen, “A loudness-level monitor for broadcasting,” IEEE Trans. on Audio and Electroacoustics, vol. 15, no. 4, 1967.
[2] International Telecommunication Union, Radiocommunication Assembly, “Algorithms to measure audio programme loudness and true-peak audio level,” Recommendation ITU-R BS.1770-4, 2015.
[3] Ernst Belger, “The loudness balance of audio broadcast programs,” in Proc. of the AES 35th Conv, October 1968.
[4] M. Vinton and C. Robinson, “Automated speech/other discrimination for loudness monitoring,” in Proc of the AES 118th Conv., May 2005.
[5] C. Uhle, “Voice activity detection,” in Speech Coding with Code Excited Linear Prediction, Tom Bäckström, Ed. Springer, 2017.
[6] Y. LeCun, B. Boser, J. S. Denker, D. Henderson, R. E. Howard, W. Hubbard, and L. D. Jackel, “Backpropagation applied to handwritten ZIP code recognition,” Neural Computation, vol. 1, 1989.
[7] R. Caruana, “Multitask learning: A knowledge-based source of inductive bias,” in Proc. of the Tenth Int. Conf. on Machine Learning, 1993.
[8] J. Baxter, “A model of inductive bias learning,” J. of Artificial Intelligence Research, 2000.
[9] Y. Zhang and Q. Yang, “A survey on multi-task learning,” arXiv preprint arXiv:1707.08114v2, 2018.
[10] A. Benton, M. Mitchell, and D. Hovy, “Multitask learning for mental health conditions with limited social media data,” in Proc. of the 15th Conf. of the European Chapter of the Association for Computational Linguistics, 2017.
[11] T. Standley, A. R. Zamir, D. Chen, L. Guibas, J. Malik, and S. Savarese, “Which tasks should be learned together in multi-task learning?,” in Proc. of the 37^{th} Int. Conf. on Machine Learning, 2020.
[12] R. Collobert and J. Weston, “A unified architecture for natural language processing: Deep neural networks with multitask learning,” in Proc. of the Int. Conf. on Machine Learning, 2008.
[13] H. M. Alonso and B. Plank, “When is multitask learning effective? Semantic sequence prediction under varying data conditions,” in Proc. of the 15th Conf. of the European Chapter of the Association for Computational Linguistics: Volume 1, Long Papers, 2017.
[14] J. Bingel and A. Søgaard, “Identifying beneficial task relations for multi-task learning in deep neural networks,” in Proc. of the 15th Conf. of the European Chapter of the Association for Computational Linguistics, 2017.
[15] F. Xiong, S. Goetze, B. Kollmeier, and B. T. Meyer, “Joint estimation of reverberation time and early-to-late reverberation ratio from single-channel speech signals,” IEEE/ACM Trans. on Audio, Speech, and Language Processing, vol. 27, no. 2, 2019.
[16] A. Maurer, M. Pontil, and B. Romera-Paredes, “The benefit of multi-task learning,” J. of Machine Learning Research, 2016.
[17] H. Fletcher and W. A. Munson, “Loudness, its definition, measurement and calculation,” J. Acoust. Soc. Am., vol. 5, pp. 82-108, 1933.
[18] M. R. Schroeder, “Models of hearing,” in Proc. of the IEEE, 1975.
[19] E. Zwicker, H. Fastl, U. Widmann, K. Kurakata, S. Kuwano, and S. Namba, “Program for calculating loudness according to DIN 45631 (ISO 532b),” J. Acoust. Soc. Jpn, vol. 12, 1991.
[20] B. C. J. Moore and B. R. Glasberg, “A revision of Zwicker's loudness model,” Acustica—Acta Acustica, vol. 82, pp. 335-345, 1996.
[21] B. C. J. Moore, B. R. Glasberg, and T. Baer, “A model for the prediction of thresholds, loudness, and partial loudness,” J. Audio Eng. Soc., vol. 45, pp. 224-240, 1997.
[22] B. R. Glasberg and B. C. J. Moore, “A model of loudness applicable to time-varying sounds,” J. Audio Eng. Soc., vol. 50, pp. 331-342, 2002.
[23] International Telecommunication Union, Radiocommunication Assembly, “Algorithms to measure audio programme loudness and true-peak audio level,” Recommendation ITU-R BS.1770, 2006.
[24] European Broadcast Union, “Loudness normalization and permitted maximum level of audio signals,” 2010.
[25] A. Travaglini, A. Alemanno, and A. Uncini, “HELM: High efficiency loudness model for broadcast content,” in Proc. of the AES 132nd Conv., 2012.
[26] Brecht De Man, “Evaluation of implementations of the EBU R128 loudness measurement,” in Proc. of the AES 145th Conv., 2018.
[27] G. A. Soulodre and S. G. Norcross, “Objective measures of loudness,” in Proc. of the AES 115th Conv, 2003.
[28] S.-Y. Chang, B. Li, G. Simko, T. N. Sainath, A. Tripathi, A. v. d. Oord, and O. Vinyals, “Temporal modeling using dilated convolution and gating for voice-activity-detection,” in Proc. of ICASSP, 2018.
[29] S. Hershey et. al., “Cnn architectures for large-scale audio classification,” in Proc. of ICASSP, 2017.
[30] J. Salamon and J. P. Bello, “Deep convolutional neural networks and data augmentation for environmental sound classification,” IEEE Sig. Proc. Letters, vol. 24, 2017.
[31] K. Simonyan and A. Zisserman, “Very deep convolutional networks for large-scale image recognition,” in Proc. of ICLR, 2015.
[32] O. Russakovsky, J. Deng, H. Su, J. Krause, S. Satheesh, S. Ma, Z. Huang, A. Karpathy, A. Khosla, M. S. Bernstein, A. C. Berg, and F.-F. Li, “Imagenet large scale visual recognition challenge,” https://arxiv.org/abs/1409.0575, 2014.
[33] V. Nair and G. E. Hinton, “Rectified linear units improve restricted boltzmann machines,” in Proc. of the 27th Int. Conf. on Machine Learning, 2010.
[34] D. Kingma and J. Ba, “Adam: A method for stochastic optimization,” in Proc. of the Int. Conf. on Learning Representations, 2015.
[35] K. He, X. Zhang, S. Ren, and J. Sun, “Delving deep into rectifiers: Surpassing human-level performance on imagenet classification,” in Proc. of the 2015 IEEE Int. Conf. on Computer Vision, 2015.
[36] European Broadcast Union, “Loudness metering to supplement EBU R 128 loudness normalization,” 2016.

1. An apparatus for providing an estimate of a loudness of signal components of interest of an audio signal, wherein the apparatus comprises:
an input interface configured to receive a plurality of samples of the audio signal, and
a neural network configured to receive as input values the plurality of samples of the audio signal or a plurality of derived values being derived from the plurality of samples of the audio signal, and configured to determine at least one output value from the plurality of input values, such that the at least one output value indicates the estimate of the loudness of the signal components of interest of the audio signal.

2. The apparatus according to claim 1,
wherein the audio signal simultaneously comprises the signal components of interest and other signal components of the audio signal,
wherein an influence of the other signal components on the estimate of the loudness of the signal components of interest is reduced or not present.

3. The apparatus according to claim 1,
wherein the signal components of interest of the audio signal are speech components of the audio signal, and
wherein the neural network is configured to determine the at least one output value from the plurality of input values, such that the at least one output value indicates the estimate of the loudness of the speech components of the audio signal.

4. The apparatus according to claim 3,
wherein the audio signal simultaneously comprises the speech components and background components of the audio signal,
wherein an influence of the background components on the estimate of the loudness of the speech components is reduced or not present.

5. The apparatus according to claim 1,
wherein the signal components of interest of the audio signal are sound components of at least one first sound source out of a plurality of sound sources in an environment,
wherein the audio signal simultaneously comprises the sound components of the at least one first sound source and other sound components of one or more other sound sources out of the plurality of sound sources in the environment,
wherein the neural network is configured to determine the at least one output value from the plurality of input values, such that the at least one output value indicates the estimate of the loudness of the sound components of the at least one first sound source,
wherein an influence of the other sound components of the one or more other sound sources on the estimate of the loudness of the sound components of the at least one first sound source is reduced or not present.

6. The apparatus according to claim 5,
wherein the sound components of the at least one first sound source are speech components of a first person out of a plurality of persons speaking in the environment,
wherein the other sound components of the one or more other sound sources are other speech components of one or more other persons out of the plurality of persons speaking in the environment,
wherein the audio signal simultaneously comprises the speech components of the first person and the other speech components of the one or more other persons speaking in the environment,
wherein the neural network is configured to determine the at least one output value from the plurality of input values, such that the at least one output value indicates the estimate of the loudness of the speech components of the first person,
wherein an influence of the other speech components of the one or more other persons on the estimate of the loudness of the speech components of the first person is reduced or not present.

7. The apparatus according to claim 5,
wherein the sound components of the at least first sound source are sound components of at least one non-human sound source out of a plurality of non-human sound sources in an environment,
wherein the other sound components of the one or more other sound sources are other sound components of one or more other non-human sound source out of the plurality of non-human sound sources,
wherein the audio signal simultaneously comprises the sound components of the at least one first non-human sound source and the other sound components of the one or more other non-human sound sources in the environment,
wherein the neural network is configured to determine the at least one output value from the plurality of input values, such that the at least one output value indicates the estimate of the loudness of the sound components of the at least one first non-human sound source,
wherein an influence of the other sound components of the one or more other non-human sound sources on the estimate of the loudness of the sound components of the at least one first non-human sound source is reduced or not present.

8. The apparatus according to claim 5,
wherein the sound components of the at least one first sound source is a singing of one or more singers in the environment,
wherein the other sound components of the one or more other sound sources are sound components of accompanying musical instruments, which accompany the singing of the one or more singers in the environment,
wherein the audio signal simultaneously comprises the signing of the one or more singers and the sound components of the accompanying musical instruments,
wherein the neural network is configured to determine the at least one output value from the plurality of input values, such that the at least one output value indicates the estimate of the loudness of the singing,
wherein an influence of the sound components of accompanying musical instruments on the estimate of the loudness of the singing is reduced or not present.

9. The apparatus according to claim 1,
wherein the neural network is configured to determine at least one further output value indicating an estimate of a loudness of the entire audio signal.

10. The apparatus according to claim 1,
wherein the neural network is configured to determine one or more further output values indicating an estimate of a loudness of the audio signal when speech is present.

11. The apparatus according to claim 1,
wherein the neural network is configured to determine another one or more output values indicating an estimate of a loudness of background components of the audio signal.

12. The apparatus according to claim 1,
wherein the apparatus is configured to determine and output at least one other output value indicating an estimate of a partial loudness of the speech components of the audio signal,
wherein the partial loudness of the speech components of the audio signal depends on the loudness of the speech components of the audio signal and on the loudness of background components of the audio signal.

13. The apparatus according to claim 1,
wherein the apparatus comprises a postprocessor, configured to modify the estimate of the loudness of the signal components of interest of the audio signal depending on confidence information, and/or configured to output the confidence information,
wherein the confidence information indicates a reliability on whether or not the estimate of the loudness of the signal components of interest of the audio signal conducted by the neural network is reliable, or wherein the confidence information indicates one or more values indicating a degree of reliability of the estimate of the loudness of the signal components of interest of the audio signal conducted by the neural network.

14. The apparatus according to claim 13,
wherein the postprocessor is configured to determine as the confidence information whether or not the at least one output value provided by the neural network indicates that the estimate of the loudness of the signal components of interest of the audio signal would be higher than a total loudness of the audio signal, and
wherein, if the at least one output value provided by the neural network indicates that the estimate of the loudness of the signal components of interest of the audio signal would be higher than a total loudness of the audio signal,
the postprocessor is configured to modify the estimate of the loudness of the signal components of interest such that the loudness of the signal components of interest of the audio signal is equal to the total loudness of the audio signal, or
the postprocessor is configured to output the confidence information comprising an indication that the estimate of the loudness of the signal components of interest of the audio signal is not reliable.

15. The apparatus according to claim 13,
wherein the postprocessor is configured to determine and to output the confidence information comprising a confidence value that indicates the degree of reliability of the estimate of the loudness of the signal components of interest of the audio signal conducted by the neural network, such that the confidence value depends on the estimate of the loudness of the signal components of interest of the audio signal and further depends on a loudness or an estimate of a loudness of the other signal components of the audio signal.

16. The apparatus according to claim 15,
wherein the confidence value depends on a difference between the estimate of the loudness of the signal components of interest of the audio signal and the loudness or the estimate of the loudness of the other signal components of the audio signal, or
wherein the confidence value depends on a ratio of the estimate of the loudness of the signal components of interest of the audio signal and the loudness or the estimate of the loudness of the other signal components of the audio signal.

17. The apparatus according to claim 1
wherein the neural network has been trained using a plurality of data training items,
wherein each of the plurality of data training items comprises one of a plurality of audio training signal portions and one or more reference loudness values.

18. The apparatus according to claim 17,
wherein the neural network has been trained depending on a loss function,
wherein, to determine a return value of the loss function during training, the neural network is configured to determine one or more loudness value estimates of the audio training signal portion for each of one or more data training items of the plurality of data training items, and
wherein the neural network has been trained depending on the loss function such that a return value of the loss function depends on the one or more loudness value estimates of the audio training signal portion and on the one or more reference loudness values of each of the one or more data training items.

19. The apparatus according to claim 18,
wherein one of the one or more reference loudness values of a data training item of the one or more data training items indicates a loudness of the signal components of interest of the audio training signal portion of the data training item, and wherein one of the one or more loudness value estimates of the data training item indicates an estimate of said loudness of the signal components of interest of the audio training signal portion of the data training item by the neural network; and/or
wherein one of the one or more reference loudness values of a data training item of the one or more data training items indicates a loudness of the other signal components of the audio training signal portion of the data training item, and wherein one of the one or more loudness value estimates of the data training item indicates an estimate of said loudness of the other signal components of the audio training signal portion of the data training item by the neural network; and/or
wherein one of the one or more reference loudness values of a data training item of the one or more data training items indicates a loudness of the entire audio training signal portion of the data training item, and wherein one of the one or more loudness value estimates of the data training item indicates an estimate of said loudness of the entire audio training signal portion of the data training item by the neural network; and/or
wherein one of the one or more reference loudness values of a data training item of the one or more data training items indicates a loudness of the audio training signal portion of the data training item when speech is present, and wherein one of the one or more loudness value estimates of the data training item indicates an estimate of said loudness of the audio training signal portion of the data training item by the neural network when speech is present, and/or
wherein one of the one or more reference loudness values of a data training item of the one or more data training items indicates a partial loudness of the signal components of interest the audio training signal portion of the data training item, and wherein one of the one or more loudness value estimates of the data training item indicates an estimate of said partial loudness of the signal components of interest of the audio training signal portion of the data training item by the neural network.

20. The apparatus according claim 18,
wherein the loss function is defined according to
$$Loss = \frac{1}{N} {\sum }_{i = 1}^{N} {( {estimate}_{i} - {reference}_{i} )}^{p}$$
wherein Loss indicates the return value of the Loss function,
wherein estimateᵢ indicates one of the one or more loudness value estimates of an i-th data training item of the one or more data training items,
wherein referenceᵢ indicates one of the one or more reference loudness values of the i-th data training item of the one or more data training items,
wherein p≥1, and wherein N≥1.

21. The apparatus according to claim 18,
wherein the neural network has been trained by iteratively adjusting the plurality of weights of the plurality of neural nodes of the neural network,
wherein, in each iteration step of a plurality of iteration steps, the plurality of weights of the plurality of neural nodes of the neural network has been adjusted depending on one or more errors returned by the loss function in response to receiving the one or more data training items.

22. The apparatus according to claim 17,
wherein one of the one or more reference loudness values of one of the one or more data training items depends on one or more modified coefficients of the audio training signal portion of the data training item,
wherein the one or more modified coefficients of the audio training signal portion of the data training item depends on one or more initial coefficients of the audio training signal portion of the data training item.

23. The apparatus according to claim 22,
wherein the one or more modified coefficients of the audio training signal portion of the data training item depend on an application of a filter on the one or more initial coefficients of said audio training signal portion, or
wherein the one or more modified coefficients of the audio training signal portion of the data training item depend on a spectral weighting of the one or more initial coefficients of the signal components of interest of said audio training signal portion.

24. The apparatus according to claim 23,
wherein the one or more modified coefficients indicate an squaring of each of one or more filtered coefficients which result from the application of the filter on the one or more initial coefficients, or
wherein the one or more modified coefficients indicate an squaring of each of one or more spectrally weighted coefficients which result from the spectral weighting of the one or more initial coefficients.

25. The apparatus according to claim 23,
wherein the filter depends on a psychoacoustic model, or
wherein the spectral weighting depends on the psychoacoustic model.

26. The apparatus according to claim 22,
wherein said one of the one or more reference loudness values depends on a sum or a weighted sum of at least two of the modified coefficients.

27. The apparatus according to claim 26,
wherein said one of the one or more reference loudness values depends on
$$L = {a ( \frac{1}{N} {\sum }_{1}^{T} {x}^{2} )}^{b}$$
wherein x² indicates a square of a modified coefficient of the at least two of the modified coefficients,
wherein T is an integer indicating a number of the at least two of the modified coefficients,
wherein a and N are predefined numbers, and
0<b<1.

28. The apparatus according to claim 26,
wherein said one of the one or more reference loudness values depends on
$$L = a {log}_{b} ( \frac{1}{N} {\sum }_{1}^{T} {x}^{2} )$$
wherein x² indicates a square of a modified coefficient of the at least two of the modified coefficients,
wherein T is an integer indicating a number of the at least two of the modified coefficients,
wherein log indicates a logarithmic function being the compressive function, and
wherein a, b and N are predefined numbers.

29. The apparatus according to claim 1,
wherein the neural network comprises an input layer, two or more hidden layers, and an output layer,
wherein the input layer comprises a plurality of input nodes, wherein each of the plurality of input nodes is configured to receive one of the plurality of input values,
wherein each of the two or more hidden layers comprises one or more neural nodes, and
wherein the output layer comprises at least one output node, wherein the at least one output node is configured to output the at least one output value indicating the estimate of the loudness of the signal components of interest of the audio signal.

30. The apparatus according to claim 29,
wherein at least one layer of the two or more hidden layers is a convolutional layer.

31. The apparatus according to claim 30,
wherein the neural network is configured to employ a convolutional filter for the convolutional layer, which comprises a shape (x, y), with x=y or with x≠y, wherein max (x, y)≤10.

32. The apparatus according to claim 29,
wherein at least one layer of the two or more hidden layers is a fully connected layer.

33. The apparatus according to claim 29,
wherein the hidden layers comprise at least one convolutional layer, at least one pooling layer, and at least one fully connected layer.

34. The apparatus according to claim 29,
wherein the apparatus is configured to employ linear activation in the output layer of the neural network.

35. The apparatus according to claim 1,
wherein the input interface is configured to receive a plurality of spectral samples of the audio signal as the plurality of input values, and
the neural network is configured to determine the estimate of the loudness of the signal components of interest of the audio signal depending on the plurality of power spectral samples of the audio signal.

36. The apparatus according to claim 35,
wherein the plurality of spectral samples are power spectral samples of at least 32 frequency bands.

37. The apparatus according to claim 35,
wherein the plurality of spectral samples of the audio signal represent the audio signal in a time-frequency domain.

38. The apparatus according to claim 37,
wherein the apparatus further comprises a transform module configured for transforming the audio signal from a time domain to the time-frequency domain to acquire the plurality of spectral samples of the audio signal.

39. The apparatus according to claim 38,
wherein the transform module is configured to transform segments of the audio signal of at least 100 ms length from the time domain to the time-frequency domain to acquire the plurality of spectral samples of the audio signal.

40. The apparatus according to claim 35,
wherein a first group of two or more of the plurality of spectral samples relate to a first group of frequency bands, which each exhibit a bandwidth that deviates by no more than 10% from a predefined first bandwidth,
wherein a second group of two or more of the plurality of spectral samples relate to a second group of frequency bands, which each exhibit a higher center frequency than each frequency band of the first group of frequency bands, and which each exhibit a bandwidth being higher than the bandwidth of each frequency band of the first group.

41. The apparatus according to claim 40,
wherein a third group of two or more of the plurality of spectral samples relate to a third group of frequency bands, which each exhibit a higher center frequency than each frequency band of the second group of frequency bands, which each exhibit a bandwidth being higher than the bandwidth of each frequency band of the second group, and
wherein the bandwidth of each frequency band of the third group deviates less from an equivalent rectangular bandwidth than the bandwidth of each frequency band of the second group.

42. A system for modifying an audio input signal to acquire an audio output signal, wherein the system comprises:
an apparatus according to claim 1 for providing an estimate of a loudness of signal components of interest of the audio input signal, and
a signal processor configured to modify the audio input signal depending on the estimate of the loudness of the signal components of interest of the audio input signal to acquire the audio output signal.

43. The system according to claim 42,
wherein the signal components of interest of the audio signal are speech components of the audio signal,
wherein the signal processor configured to modify the audio input signal depending on the estimate of the loudness of the speech components of the audio input signal to acquire the audio output signal.

44. The system according to claim 43,
wherein the signal processor is configured to modify the audio input signal depending on the estimate of the loudness of the speech components of the audio input signal and depending on an estimation of the loudness of the background components of the audio input signal to acquire the audio output signal.

45. The system according to claim 44,
wherein the apparatus for providing an estimate of a loudness of speech components of the audio input signal is an apparatus configured to determine and output at least one other output value indicating an estimate of a partial loudness of the speech components of the audio signal,
wherein the partial loudness of the speech components of the audio signal depends on the loudness of the speech components of the audio signal and on the loudness of background components of the audio signal,
wherein the signal processor is configured to modify a level of the audio input signal depending on the partial loudness of the speech components of the audio signal.

46. A method for providing an estimate of a loudness of signal components of interest of an audio signal, wherein the method comprises:
receiving a plurality of samples of the audio signal, and
estimating the loudness of the signal components of interest of the audio signal,
wherein a neural network receives as input values the plurality of samples of the audio signal or a plurality of derived values being derived from the plurality of samples of the audio signal, and
wherein the neural network determines at least one output value from the plurality of input values, such that the at least one output value indicates the estimate of the loudness of the signal components of interest of the audio signal.

47. A non-transitory digital storage medium having stored thereon a computer program for performing a method of for providing an estimate of a loudness of signal components of interest of an audio signal, wherein the method comprises:
receiving a plurality of samples of the audio signal, and
estimating the loudness of the signal components of interest of the audio signal,
wherein a neural network receives as input values the plurality of samples of the audio signal or a plurality of derived values being derived from the plurality of samples of the audio signal, and
wherein the neural network determines at least one output value from the plurality of input values, such that the at least one output value indicates the estimate of the loudness of the signal components of interest of the audio signal,
when the computer program is run by a computer or signal processor.
